(19) United States
(12) Patent Application Publication
(10) Pub. No.: US 2012/0036373 A1
(43) Pub. Date: Feb. 9, 2012

(54) Method system and device for secure firmware programming

(75) Inventors: Vyacheslav Kofman, Holon (IL); Ariel Kochen, Petah Tikva (IL)

(73) Assignee: SOFTLOG SYSTEMS (2006) LTD., Rishon-Letzion (IL)

(21) Appl. No.: 12/805,565

(22) Filed: Aug. 5, 2010

(51) Int. Cl. G06F 12/14; G06F 21/22

(52) U.S. Cl. 713/193; 726/26

(57) ABSTRACT

The present invention provides a secure firmware programming technique wherein a corrupted version of the binary image code to be programmed in microcontroller devices is loaded into a modified programmer device which is adapted to receive the corrupted binary image code, transfer code sections of the corrupted binary image code to the memory of the programmed microcontroller, restore corrupted code sections of the corrupted binary image code and transfer them to the programmed microcontroller in order to restore the binary image code stored therein into its original executable state.

### FIELD OF THE INVENTION

The present invention generally relates to secure firmware programming of programmable microcontrollers. More particularly, the invention relates to a method, system and device for securing firmware program code data and for preventing unauthorized use and copying thereof, and tampering therewith.

### BACKGROUND OF THE INVENTION

Programmable microcontrollers (e.g., Microchip PICs) are integrated circuit chips comprising processing means (e.g., central processing unit—CPU), nonvolatile memory means (e.g., EPROM, EEPROM, FLASH) employed for storing program code to be executed by the processor, and any other data needed for the IC (integrated chip) microcontroller operation, and often also volatile memories (e.g., RAM, FRAM, MRAM). The process of writing the program code into the nonvolatile memory of the microcontroller is referred to as microcontroller programming or firmware programming.

Programmable microcontrollers are used in electronic circuitry in a wide range of applications. In many cases there is a need to update the program code stored in the nonvolatile memory of the microcontroller, in which cases an in-circuit programmable (ICP) microcontroller is advantageously used. In in-circuit programming the microcontroller nonvolatile memory is accessed by means of a programmer device capable of programming it with the new code (commonly referred to as binary image, “hex” or “bin” file) without requiring removal of the IC chip from the printed circuit board (PCB) on which it is mounted. Typically, the binary image code to be programmed into the nonvolatile memory is loaded to a loader program running on a computer machine (e.g., personal computer—PC), which transfers the binary image data and firmware programming parameters (also known as programming environment) to the programmer device. After the programmer device is loaded with the binary image data and the needed programming parameters, the data is transferred by it into the microcontroller, wherein it is saved in its nonvolatile memory.

ICP microcontrollers are used nowadays in a wide range of applications. In many events, the development and engineering of products are carried out in separate from the actual manufacturing of the products, which usually requires shipping the binary image code to remote manufacturing sites (subcontractors) with very limited control over it, which renders it vulnerable to tampering, copying, with no control over the number of products into which the code is being programmed. Such difficulties are also encountered in applications in which there is a need to routinely update the microcontroller code by the end users themselves, thus requiring that the binary image code be provided to each and every user who purchased the products comprising such programmed firmware.

Some level of protection may be obtained by employing cryptography means. For example, the binary image code may be encrypted before it is shipped to the manufacturer or end-users. The encrypted binary image code may be then loaded by the loader program to the programmer, which decrypts and transfers the decrypted binary image data to the programmer device. While such cryptography means may provide some level of security against copying and tampering, the decrypted code may be intercepted by simple eavesdropping means in the computer running the loader program. Furthermore, such cryptography solutions do not permit the monitoring and controlling the number of products into which the binary image data is programmed.

Moreover, when such cryptography means are the only security means used the binary image code may be still intercepted in the programmer device. Another way to copy the programmed code is carried out after programming the microcontroller with the binary code data and then disconnecting it from the programmer device before activation of its security bit (also known as copy protection or lock feature), and then copying the binary image data from the controller memory.

Improved protection can be gained by means of a decrypting bootloader used on the ICP microcontroller, and in this case the encrypted binary image code is transferred by the programmer device to the ICP microcontroller, which is adapted to decrypt and write the decrypted data into predefined memory locations in its nonvolatile memory. While this solution is substantially tamper and copy proof, it consumes precious resources of the ICP microcontroller required for the decrypting bootloader code, and it is only applicable in certain types of microcontrollers having self-write capabilities. Additionally, the decrypting bootloader type of protection does not provide means for monitoring and controlling the number of instances that the binary image data is being programmed into ICP devices.

A possible solution for controlling the number of binary image data instances transferred to ICP chips may be obtained by employing a portable firmware programmer, such as FlexiPanel TEAclipper/PIC (FlexiPanel Ltd., London, UK), for example. In this approach the firmware programmer is connected temporarily to the PCB of the ICP chip directly, where the firmware programmer is configured to permit a limited number of binary image data transfers. However, this type of solution is still vulnerable to the attacks described hereinabove.

There is therefore a need for microcontroller programming solutions that can overcome the above mentioned problems.

It is an object of the present invention to provide a method and system for securely transferring binary image data to programmable microcontroller devices for substantially reducing or preventing unauthorized copying and tampering therewith.

It is another object of the present invention to provide a method and apparatus for securely transferring binary image code from a programmer device to ICP device(s) and substantially reducing or preventing interception thereof by eavesdropping means.

It is a further object of the present invention to provide a method and system for controlling, monitoring and limiting, the number of microcontroller devices into which binary image data is programmed.

Other objects and advantages of the invention will become apparent as the description proceeds.

### SUMMARY OF THE INVENTION

The present invention provides a secure firmware programming technique that is useful for substantially reducing, or preventing, the copying of, and tampering with, the binary image code to be programmed into memory of microcontroller devices, and that further provides control over the number of devices into which the binary image code is programmed.

These goals of the present invention are generally achieved by generating a corrupted version of the binary image code and by means of a modified programmer device of the invention which is adapted to receive the corrupted version of the binary image code by means of a standard loader application, transfer the corrupted binary image code to the memory of the programmed microcontroller, restore corrupted code sections of the binary image code stored in the memory of the programmed microcontroller in order to restore the binary image code stored therein into its original executable state, and immediately thereafter lock the microcontroller memory (e.g., setting the protection bit into its ON state). The code restoration and memory locking steps are designed to be rapidly performed after the corrupted binary image code is written into the microcontroller memory such that attempts to copy the binary image code written into the microcontroller memory will most probably result in obtaining the corrupted version of the binary image code before it is restored.

For example, the binary image code may be corrupted by the developer by means of reversible operators (e.g., XORing, bit shifting, modular arithmetic operators, or any other reversible scrambling technique) allowing the modified programmer to restore the corrupted sections of the binary image code after it is transferred into the microcontroller memory by applying the inverse operators to the corrupted sections of the binary image code.

The modified programmer device of the invention may be implemented by means of a standard programmer (e.g., ICP2 or ICP2-GANG by Softlog Systems (2006) Ltd.) configured to carry out a sequence of binary code restoration actions to predetermined address locations and address ranges of the corrupted binary code transferred by it to the microcontroller memory, in order to restore it back into its executable state. In this approach, end users are provided with the modified programmer device and whenever there is a need to program a new binary image code into microcontroller devices the developer (also referred to herein as designer or administrator) generates a corrupted version of the binary image code, wherein the corruptions introduced to the binary image code can be restored by the modified programmer device of the invention to restore it back into its executable state in the microcontroller memory, as described hereinabove. Accordingly, proper firmware programming using the corrupted binary image code is possible only by means of the modified programmer device of the invention.

The inverse operators required for restoring the corrupted code sections, and the address locations and ranges to which these inverse operators should be applied, are preferably stored in a secure memory provided in the modified programmer device of the invention. The secure memory of the modified programmer preferably further comprises a password and/or cryptographic key(s) stored therein for allowing it to carry out cryptographic tasks. The cryptographic key(s) used may be a type of symmetric or asymmetric cryptographic keys, or any other suitable cryptography system, or combinations thereof.

In specific preferred embodiments of the invention the modified programmer is adapted to transfer to the programmed microcontroller only sections of the corrupted binary image code which were not corrupted (i.e., non-corrupted code sections), restore the corrupted code sections of the corrupted binary image code by applying inverse operators, as defined in the secure memory of the modified programmer, and thereafter transfer the restored code sections into their respective address locations in the memory of the programmed microcontroller, such that the code obtained in the memory of the microcontroller is the original executable binary image code required for its operation.

The secure memory is preferably provided as part of an integrated circuit chip comprising the processing means (cpu) and additional components of the programmer device, as may be needed, wherein the integrated circuit chip is designed such that the internal memory may be accessed only by means of the (on-chip) processing means.

Preferably, the corrupted image code is obtained by removal of code sections from the binary image code and by storing the removed code sections, and their address locations therein, in the secure memory of the modified programmer device. The code sections removed from the binary image code are preferably code sections of crucial importance for proper operation of the binary image code. Most preferably, the locations from which binary image code sections were removed are filled with dummy random values such that the corrupted binary image code can not execute properly or even rendering it non-executable. In this preferred embodiment for each specific binary image code a particular modified programmer is prepared accordingly to comprise in its secure memory the code sections removed from the binary image code and the address locations and ranges of these code sections.

In order to further control the number of microcontroller devices into which the binary image data is programmed the developer may define security parameters which are stored in the secure memory of the modified programmer device of the invention. The security parameters may comprise a counter value, and the programmer device may be further modified to decrement (e.g., by 1) the counter value stored in its secure memory whenever a successful binary image data transfer operation is performed, and to permit transfer of the binary image code only if the counter value is greater than zero. Alternatively, the programmer may be configured to transfer the corrupted version of the binary image code without performing the needed restoration actions whenever the user attempts to carry out further firmware programming after the counter value is zeroed.

Accordingly, the secure firmware programming technique of the invention allows the developer to limit the number of binary image code transfers to a predetermined number of microcontroller devices. Since the developer using the secure firmware programming technique of the invention provides only corrupted versions of the binary image code, any attempt of the end user to transfer this corrupted binary image code without the modified programmer of the invention will result with microcontrollers programmed with a corrupted program code, which will not operate properly and which is most probably not executable.

In some preferred embodiments of the invention the binary image data transfer operation is generally comprised of the following steps: i) transfer of the corrupted image code into the microcontroller memory; ii) restoration of the corrupted code sections in the microcontroller memory; and iii) lock of the microcontroller memory (e.g., setting the protection bit into its ON state). The binary image data transfer may further comprise steps for verifying that the microcontroller memory is unlocked and a verification step to confirm that the microcontroller memory is indeed locked after carrying out step iii) above.

Most preferably, the corrupted binary image code, security parameters and any other data, may be provided by the developer to the end users in an encrypted form. In this way the developer provides the end users with encrypted data comprising the corrupted binary image code and the security parameters comprising the counter value, such that the end user can not tamper with this data.

The encrypted data provided by the developer may be decrypted by the modified programmer by means of the password and/or cryptographic key(s) stored in its secure memory, after the encrypted data is loaded into the modified programmer by the user. The decrypted data may be stored in the secure memory of the modified programmer. Alternatively, the modified programmer may store the encrypted corrupted binary image code in an external memory, decrypt only data and security parameters needed for its operation and store the decrypted data in the secure memory, if so needed. In this way the encrypted corrupted binary image code stored in the external memory may be decrypted by the modified programmer only when data transfer operations are performed.

Once the counter value stored in the secure memory of the modified programmer is zeroed, in order to carry out further binary image code transfers the end user is required to make a new order indicating the exact number of microcontrollers to be programmed with the binary image code. Upon receipt of such order the developer can generate a new encrypted data packet comprising the previously used corrupted binary image code and security parameters comprising a new counter value according to the number of binary image code transfers required by the end user. The encrypted packet is sent to the end user, and once loaded into the modified programmer device can be used for carrying out a number of additional binary image code transfers, as defined in the new counter value comprised in the security parameters of the encrypted packet.

The secure memory of the modified programmer device may further comprise a batch number value used for indicating a batch number of microcontroller devices programmed with the specific binary image code. In such preferred embodiments the security parameters provided with each new encrypted data packet further comprises a new batch number value to be stored in the secure memory of the modified programmer. The modified programmer device of the invention is preferably further adapted to compare the (old) batch number value stored in the secure memory with the new batch number provided in any new encrypted data packet, and allow further firmware programming only if the new batch number received in the new encrypted data packet is greater than the (old) batch number value stored in the security memory of the modified programmer. When this condition is met, the new batch number value received is stored in the secure memory of the modified programmer in place of the old batch number value.

On the other hand, if the new batch number comprised in the security parameters is not greater than the old batch number value stored in the secure memory of the modified programmer, values provided in the security parameters (e.g., new counter value and new batch number value) will not be stored in the secure memory of the modified programmer. In this way repeated use of the same encrypted data packet by the user is prevented since any attempt to re-load the same encrypted data packet will be denied because the batch number values in the secure memory of the modified programmer and in the encrypted data packet will be the same.

Typically, the batch number value in any new encrypted data packet is incremented by 1, but it may be incremented by any other positive value, and the modified programmer will accept such new batch number value as long as they are greater than the old batch number value stored in the secure memory of the modified programmer. Therefore the batch number value is continuously updated whenever the end user loads a new encrypted data packet comprising corrupted binary image code and security parameters, such that it may serve as an order number counter.

According to one specific preferred embodiment of the invention the corrupted binary image code is generated by removal of code sections from the binary image code and by substituting in the locations from which binary image code sections were removed dummy random values. The removed code sections and their address locations and ranges in the binary image are stored in the secure memory of the modified programmer device of the invention. In this approach a modified programmer comprising the removed code sections and password and/or cryptographic key(s) stored in its secure memory, is produced and tailored for a specific binary image code, or for associated products/projects. The modified programmer may be then shipped to the end user for setting up a firmware programming line.

Whenever there is a need to program a predefined number of microcontroller devices the developer creates an encrypted packet comprising the same (previously used) corrupted binary image code and new security parameters comprising a counter value set according to the number of microcontroller devices to be programmed. The encrypted packet is then sent to the end user and loaded into the modified programmer by means of a standard loader application. In order to perform firmware programming the modified programmer device decrypts the loaded data by means of the password and/or cryptographic key(s) stored in its secure memory, and carry out binary image code transfers as follows: first the corrupted binary image code is transferred into the memory of the microcontroller device; thereafter, the removed code sections stored in the secured memory of the modified programmer device are transferred into their respective address locations in the memory of the programmed microcontroller device; and immediately thereafter, the microcontroller memory is locked (e.g., setting the protection bit into its ON state).

In possible preferred embodiments of the invention, whenever there is a need to program a predefined number of microcontroller devices the developer creates an encrypted packet comprising only the new security parameters needed for setting a new counter value in the secure memory of the modified programmer. Namely, the corrupted binary image code may be provided to the user only with the first encrypted packet, and after it is loaded into the modified programmer it may be repeatedly used by modifying the batch number and the counter value in the secure memory of the modified programmer by means of such new encrypted data packets.

According to one specific preferred embodiment of the invention the transferring of the binary image code to the memory of the programmed microcontroller comprise: i) transferring sections of the binary image code which are not corrupted; ii) transferring the sections of the code stored in the secure memory of the modified programmer to their respective locations in the memory of the programmed microcontroller; and immediately thereafter iii) locking the memory of the programmed microcontroller.

In one aspect the present invention is directed to a secure programming system for securely transferring (writing) binary image code into the memory of a microcontroller device, the system may comprise a modified programmer device and a computer machine capable of loading the modified programmer device with data, wherein the modified programmer device comprises processing means and a secure memory accessible by the processing means, and wherein the modified programmer device is adapted to receive from the computer machine data comprising a corrupted binary image code comprising one or more corrupted code sections, transfer sections of the corrupted binary image code into the memory of the microcontroller, restore the one or more corrupted code sections of the corrupted binary image code and transfer them into the memory of the microcontroller in order to restore the binary image code into its original executable state, and lock the microcontroller memory.

Preferably, the modified programmer device is adapted to receive from the computer machine data comprising a corrupted binary image code, transfer the corrupted binary image code into the memory of the microcontroller, restore sections of the code written in the memory of the microcontroller in order to restore the binary image code into its original executable state, and lock the microcontroller memory.

The modified programmer device may be adapted to transfer the binary image code to the memory of the microcontroller in a sequence of data transfers and verifications comprising: i) transfer of the corrupted binary image code; ii) verification of the transferred data; iii) restoration of the at least one corrupted code section written in the memory of the microcontroller; and iv) lock of the memory of the microcontroller.

The corrupted binary image code may comprise at least one code section corrupted by means of reversible data manipulation operators, and the modified programmer may be adapted to apply corresponding inverse operators to the at least one code section stored in the memory of the microcontroller.

Preferably, the at least one code section of the binary image code is stored in the secure memory of the modified programmer device, and the locations of said at least one code section in the corrupted binary image code comprise random values, wherein the modified programmer is adapted to replace said random values comprised in the at least one code section once stored in the memory of the microcontroller with the at least one code section taken from the binary image code and stored in its secure memory. Alternatively, the modified programmer may be adapted to transfer to the microcontroller device only sections of the corrupted binary image code which are not corrupted and thereafter to transfer to the microcontroller device the at least one code section of the binary image code stored in the secure memory of the modified programmer. Preferably, the code sections removed from the binary image code are of crucial importance for proper operation of the binary image code.

The secure memory of the modified programmer may further comprise a password and/or cryptographic key(s) stored therein, and the modified programmer may be further adapted to carry out cryptographic tasks.

Advantageously, a counter field may be provided in the secure memory of the modified programmer device, which counter field comprises a counter value, wherein said modified programmer device is further adapted to decrement (e.g., by 1) the counter value stored in the counter field whenever a binary image data transfer operation is performed, and to permit transfer of the binary image code only if the value stored in the counter field is greater than zero.

Preferably, the data transferred to the modified programmer by the user comprises encrypted secure environment data comprising the corrupted binary image code and security parameters comprising the counter value, wherein the modified programmer is adapted to decrypt the encrypted secure environment data by means of the password and/or cryptographic key(s).

A batch number field may be further provided in the secure memory of the modified programmer device. Preferably, the value stored in the batch number field is replaced by a new batch number value whenever new encrypted secure environment data is loaded and decrypted in the modified programmer device. Advantageously, the new batch number value is provided in the security parameters comprised in the encrypted secure environment data, and the modified programmer is further adapted to store values provided in the security parameters only when the new batch number comprised in the security parameters is greater than the batch number value stored in the batch number field in the secure memory of the modified programmer.

Accordingly, if the batch number value provided in the security parameters is not greater than the batch number value stored in the batch number field the counter value in the counter field will not be updated and further programming of the binary image code will thus be prevented.

According to another aspect the present invention is directed to a method for securely programming a microcontroller with a binary image code comprising:
Providing a corrupted version of the binary image code in which at least one section of code was corrupted by means of reversible data manipulation operators;
Providing a modified programmer device capable of restoring the at least one corrupted section of code by applying corresponding inverse data manipulations operators;
Loading the corrupted version of the binary image code into the modified programmer; and
Operating the modified programmer to transfer sections of the corrupted version of the binary image code to a memory of the microcontroller, restore the at least one corrupted section of code and transfer it into the memory of the microcontroller, and lock the memory of the microcontroller immediately thereafter.

Preferably, the modified programmer is operated to transfer the corrupted version of the binary image code to the memory of the microcontroller, to restore the at least one corrupted section of code stored in the memory of the microcontroller, and then lock the memory of the microcontroller immediately thereafter.

The corrupted version of the binary image code may be provided by removing at least one section of code of the binary image code and storing it in a secure memory of the modified programmer, and by replacing the locations of the removed at least one section of code with random data, wherein the modified programmer device may be adapted to restore the at least one corrupted section by writing the at least one section of code stored in its secure memory into the respective locations in the memory of the microcontroller.

The data transfer operations carried out by the modified programmer may comprise transferring the corrupted version of the binary image code to a memory of the microcontroller, verification of the transferred data, restoration of the at least one corrupted code section written in said memory of said microcontroller, and lock of the memory of the microcontroller.

Preferably, the modified programmer is further adapted to decrement a counter value stored in a counter field in a secure memory of the modified programmer, wherein the modified programmer is adapted to transfer data to microcontroller devices only if the value stored in the counter field is greater than zero.

Preferably, the corrupted binary image is provided as part of an encrypted secure environment data which further comprise security parameters comprising a counter value to be stored in the counter field, wherein the modified programmer device is further adapted to decrypt the encrypted secure environment data by means of a password or cryptographic key(s) stored in its secure memory.

A batch number field may be provided in the secure memory of the modified programmer, wherein the modified programmer is adapted to replace the value stored in the batch number field with the new batch number value provided in the new encrypted secure environment data loaded into it only if the new value is greater than the old value. Correspondingly, if the new batch number value provided in the secure environment is not greater than the old batch number value stored in the batch number filed the modified programmer will not store any of the values provided in the security parameters of the encrypted secure environment data such that further programming of the binary image code will be prevented.

### BRIEF DESCRIPTION OF THE DRAWINGS

The present invention is illustrated by way of example in the accompanying drawings, in which similar references consistently indicate similar elements and in which:

FIG. 1 is a block diagram schematically illustrating a system employing a general protection approach of the invention for securing binary image data against copying and tampering;

FIG. 2 is a block diagram schematically illustrating the modified programmer and data security elements used therein in the preferred embodiment of the invention;

FIGS. 3A and 3B schematically illustrate some of the secure components, wherein FIG. 3A exemplifies construction of a secure buffer, and FIG. 3B demonstrates a possible structure of the secure data block;

FIGS. 4A and 4B are flowcharts exemplifying possible procedures for preparing components of the secure programming system according to one preferred embodiment of the invention; and

FIG. 5 schematically illustrates the steps in the secure microcontroller programming process according to a preferred embodiment of the invention.

### DETAILED DESCRIPTION OF PREFERRED EMBODIMENTS

The following detailed description should be read with reference to the drawings, in which like elements in different drawings are referenced by the same numerals, and which are not intended to limit the scope of the invention. The following description illustrates principles of the invention by way of example, not by way of limitation, and it will enable one skilled in the art to carry out the invention, according to any of the described embodiments including what is presently believed to be the best mode of the invention.

While the following description primarily relates to in-circuit programming it should be clear that the invention may be carried out in both in-circuit programming (ICP) and out-of-circuit programming, and that the invention is not limited to these firmware programming approaches only.

The present invention provides a secure ICP system, method and device, for effectively preventing unauthorized copying and tampering with the binary image data to be programmed into ICP devices, and for controlling, monitoring and limiting the number of transfers of the binary image data from the programmer device to ICP devices. Thus, the present invention also enables the designer (also referred to herein as administrator or developer) to limit the number of ICP devices to which the binary image data will be programmed, and thereby to prevent exceeding the amount of programmed ICP devices from a predefined ordered amount.

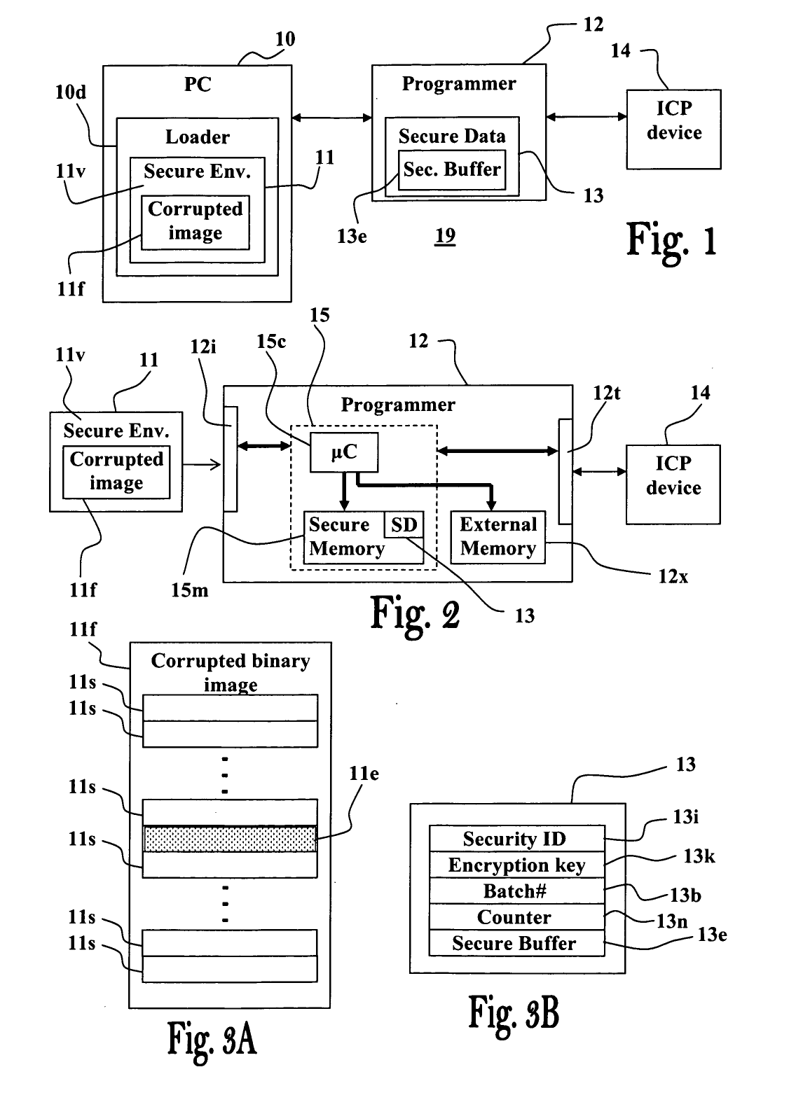

With reference to FIG. 1 showing in general one preferred embodiment of a secure ICP system 19 of the invention comprising a computer machine 10, modified programmer device 12, and the ICP device 14 to which the binary image data needs to be programmed. In this preferred embodiment of the invention the loader 10d running in computer machine 10 is loaded with a corrupted instance 11f of the binary image code to be programmed in ICP device 14.

Thus, corrupted binary image code 11f provided to the end user in this preferred embodiment is useless without the programmer device 12 of the invention, which comprises a secure data block 13 stored in its secure memory in which there is stored a secure buffer 13e comprising means for reversing the data manipulation(s) applied to code sections of the binary image code, and thereby restore it back into the original executable program code which needs to be programmed in the ICP device 14. As will be explained, in preferred embodiments of the invention the end users receive corrupted versions of the binary image code to be programmed and a modified programmer device 12 comprising the secure buffer 13e allowing the modified programmer 12 to restore the corrupted binary image code 11f, loaded into it by loader 10d, into its original executable form.

Means provided in modified programmer 12 for limiting the number of binary image data transfers from modified programmer 12 to ICP devices (14) will also be discussed in details hereinbelow.

With reference to FIG. 2, showing a general configuration of modified programmer 12 of the invention, wherein there is a protected IC unit 15 comprising processing means 15c and secure memory 15m, which are preferably integrated onto a single IC device, and an (optional) external nonvolatile-memory 12x. Processing means 15c are electronically linked to secure memory 15m and to external memory 12x units for allowing it to read and write data from these memory units. Secure memory 15m provided in protected IC unit 15 comprises the secure data block 13 comprising the information needed for restoring the corrupted binary image code 11f loaded into modified programmer 12. Modified programmer 12 is preferably a standard ICP programmer having serial/parallel input port(s) 12i operable for physically and electronically linking between protected IC unit 15 and computer machine 10 for transferring data, and control signals if needed, therebetween, and serial/parallel output port(s) 12t operable for physically and electronically linking between protected IC unit 15 and ICP devices (14) for transferring data and control signals between them.

Preferably the sections of the binary image code to which data manipulation(s) is applied are sections comprising code instructions of crucial importance for its execution, which thus render the corrupted binary image code useless (i.e., the corrupted program code can not operate properly, most probable that it is not executable at all). In a preferred embodiment of the invention the corrupted binary image is provided to the end-users encrypted, such that its restoration requires loading and decrypting it in the modified programmer device 12, and then reversing the manipulations applied to code sections of the binary image.

The secure data 13 may comprise specifications of address ranges of the code sections which been manipulated and the inverse operators that should be applied to each of these code sections in order to restore them into their original executable program code content. According to one specific preferred embodiment of the invention a consecutive section of a relatively small amount of program code is manipulated to obtain the corrupted binary image 11f. Most preferably, as demonstrated in FIG. 3A, corrupted binary image 11f is produced by removing a section 11e of program code therefrom and substituting a set of dummy values there instead. Other code sections 11s of binary image 11f are not manipulated and remain intact. For example, after removal of the original code section 11e from the binary image file, section 11e of the binary image file may be filled with zeros, or any other value within the op-code range.

Most preferably, the removed program code section 11e in the binary image file is filled with random values within the op-code range, such that it will be difficult to recognize that this specific section(s) of the binary image code was corrupted. The original program code removed from the section 11e of the binary image file is securely stored in secure buffer 13e in the secure memory 15m of modified programmer 12.

FIG. 3B shows possible structure of the secure data block 13 stored in secure memory 15m of protected IC unit 15. Secure data block 13 preferably comprises various data items pertaining to the security of the ICP system 19 and to the programming environment of the binary image code. In this example, secure data block 13 comprises a security ID identifier field 13i which is in general used for identifying the project or product to be used with modified programmer device 12, an encryption key (or password) field 13k used by modified programmer 12 to decrypt the loaded corrupted binary image code 11f and other data provided in an encrypted form, a batch number value field 13b which designates a preset binary image programming batch, a counter field 13n which defines a predetermined number of binary image data transfers to be carried out by modified programmer 12 for the specific batch number 13b, and a secure buffer 13e in which the program code removed from section 11e of the original binary image is stored. Secure buffer 13e may further comprise the memory addresses defining the location and address range of section 11e into which the removed program code should be written in order to restore the original executable binary image code. It is noted that secure memory 15m is protected at all times against any external “read” attempts.

Modified programmer 12 of the invention is configured to perform a predetermined number of binary image data transfers for a specific value stored in the batch number field 13b. More particularly, whenever there is an order to program a certain amount of ICP devices the system administrator creates a new secure environment 11v of the corrupted binary image code 11f, which are packed together and encrypted (11) before shipment to the end user. In this way, further programming of the binary image code to a certain amount of ICP devices may be enabled by the administrator by creating a new encrypted secure environment packet 11 comprising the corrupted binary image code 11f and a new counter value in the security definitions of the secure environment, which new counter value is to be stored in counter field 13n in the secure data block 13.

It is noted that the secure environment 11v, which comprises the corrupted binary image code 11f and the security definitions, preferably further comprises the standard programming environment which comprises the definitions needed by the programmer in order to transfer the binary image code to the specific microcontroller that is being programmed (e.g., voltage settings). Preferably, the security parameters included in the secure environment 11v comprise a security ID identifier, a new batch number value and a new counter value, and whenever a new encrypted secure environment packet 11 comprising the corrupted binary image code 11f and new security definitions comprised in the secure environment 11v is loaded into modified programmer device 12 the following actions are performed by modified programmer device 12:
the encrypted packet is decrypted using the password or encryption key (13k);
the security ID identifier comprised in the secure environment is compared to the security ID identifier stored in the security ID identifier field 13i in the secure memory, and if these security ID identifiers are not identical the packet is denied and no further actions are performed;
if the security ID identifiers are identical, the modified programmer compares the new batch number value comprised in the secure environment to the old batch number value stored in the batch number field 13b in the secure memory, and if the new batch number value is not greater than the old batch number value the packet is denied and no further actions are performed; and
if the new batch number is greater than the old value then the new batch number value and the new counter value comprised in the secure environment are stored in their respective fields 13b and 13n in the secure data block 13 in the secure memory 15m,

In this way any attempt of users to re-load the same secure environment and transfer further copies of the binary image code to additional microcontroller devices is prevented.

The decrypted corrupted binary image data may be stored in the secure memory 15m, or alternatively, in an encrypted form in the external memory unit 12x of modified programmer 12. Thereafter, whenever binary image data is transferred from modified programmer 12 the value stored in counter field 13n is decremented by 1, until the counter value 13n is zeroed. Once the value in counter field 13n is zeroed modified programmer 12 will not perform any further binary image transfers until a new secure environment is loaded to the modified programmer device 12 i.e., until new values are stored in the batch number 13b and counter 13n fields. It is noted that a similar effect may be obtained by incrementing the counter value in counter field 13n, but in such case the administrator is required to calculate the counter value according to the maximal value that can be stored in the counter field 13n.

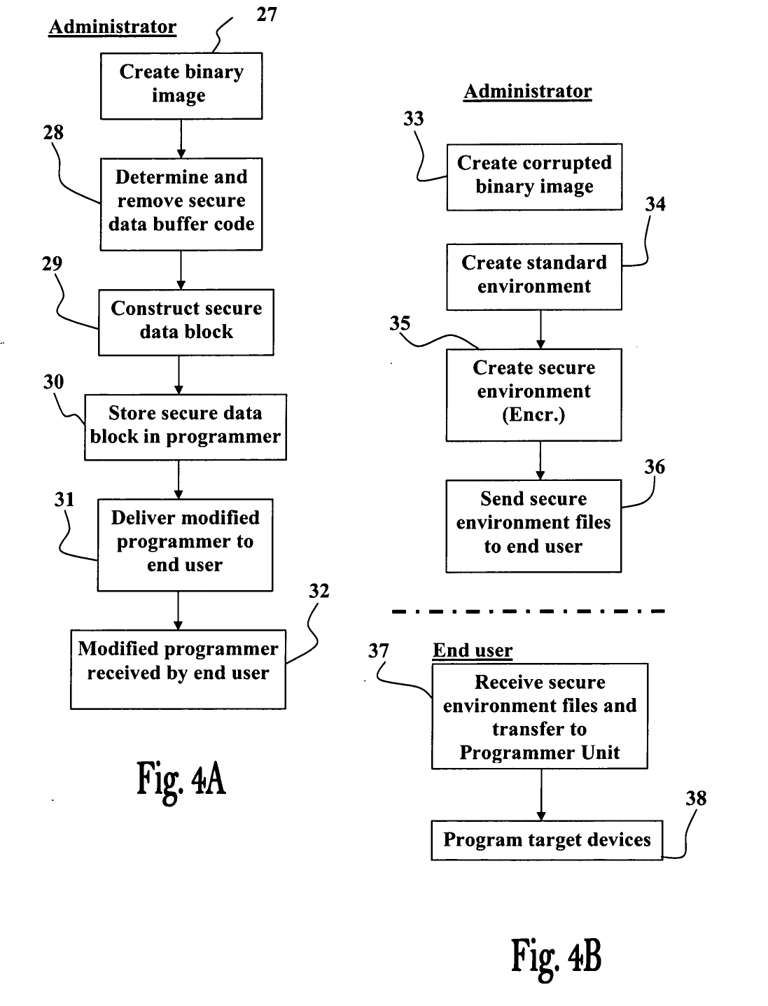

FIGS. 4A and 43 are flow charts exemplifying possible procedures for preparing components of the secure ICP system 19 of the invention and programming ICP devices using them. The process shown in FIG. 4A is carried out by the administrator, and it may be performed only once for each data image code, or for a group of binary image codes having the same secure buffer properties, to be securely programmed to ICP devices according to the present invention. The steps illustrated in FIG. 4B may be carried out routinely by the administrator and the user each time there is a new batch of microcontroller devices to be programmed with the specific binary image code used for carrying out the steps in FIG. 4A.

With reference to FIG. 4A, the process starts in step 27 wherein the administrator creates the binary image to be programmed to the ICP devices (also referred to herein as the original executable code). In step 28 the administrator determines a program code section (11e) from the binary image file to be used for the secure buffer, which is then copied to a file comprising the security data. Thereafter, in step 29 the administrator furnishes further secure data (e.g., security ID, batch number, password/encryption key) needed for the secure environment definitions.

In step 30 the secure data block (13) is written into the secure memory 15m of modified programmer 12, and in step 31 the programmer is shipped to the end user. In step 32 the modified programmer 12 is received by the end user, and thereafter all initial components needed for preparing a firmware programming setup of the invention are prepared, and can be routinely used by the end user for firmware programming by carrying out the steps illustrated in FIG. 4B.

Once the modified programmer 12 is received at the end user, the end user can assemble the secure ICP system 19 of the invention, and each time a new encrypted secure environment packet 11 is received from the administrator, the end user can transfer the binary image code to a predetermined number of ICP devices, as defined in the counter field 13n. With reference to FIG. 4B, in step 33 the binary image file is corrupted by the administrator, preferably by introducing random values into the program code section (11e) determined for use in the secure buffer (13e). Next, is step 34, the administrator creates a standard firmware programming environment (e.g., by means of “ICP for Windows” software, or the like) for the firmware programming, and in step the administrator creates an encrypted secure environment comprising the corrupted binary image code 11f, the standard firmware programming environment and security definitions to be stored in the secure data block (13) of the modified programmer 12. Though the security definitions provided in the encrypted security environment 11 may comprise new values to be stored in certain fields of the secure data block 13, it preferably does not include new values for the secure buffer 13e and for the encryption key field 13k.

It is noted that there is no need to repeatedly carry out step 33 each time a new secure environment 11v is prepared by the administrator, such that corrupted binary image code may be prepared only once and then repeatedly used whenever a new secure environment 11v is prepared. In specific cases the creation of the new encrypted secure environment packet 11 may involve only modifying the counter value (to be stored in counter field 13n) in the security definitions of the secure environment 11v according to the number of microcontroller devices to be programmed with the binary image code used in the steps of FIG. 4A. Most preferably, new values are defined in each secure environment packet 11v for the batch number (to be stored in the batch number field 13b) and for the counter (for counter field 13n) in order to prevent repeated use of the same secure environment packet.

Thereafter, in step 36 the encrypted secure environment 11 is sent to the end user, after the receipt of which, in step 37, the user loads the programmer with the encrypted secure environment 11 and in step 38 carries out a predetermined number of firmware programming as defined by the new counter value field 13n, as defined in by the secure environment received.

Whenever there is a need for a new batch of ICP devices to be programmed with the same specific binary image used in FIG. 4A, steps 34 to 38 are performed as the administrator creates a new encrypted secure environment packet 11 comprising the corrupted binary image code 11f and new security definitions for updating the value in the counter field 13n and a new value for the batch number field 13b. The new secure environment is encrypted and shipped (e.g., in any suitable storing medium or over the internet) to the end user for further secure ICP programming. As described hereinabove, the new batch number value comprised in the new secure environment should be greater than the batch number value stored in the batch number value field 13b in the secure data block 13, otherwise the new secure environment will be denied and no further actions will be performed by the modified programmer 12.

Optionally, whenever there is a need for a new batch of ICP devices to be programmed with the same specific binary image code used in FIG. 4A, a new encrypted secure environment packet 11 is produced by repeating steps 34 to 38 without including the corrupted binary image code, but to only define new security definitions for updating the values in the counter field 13n and the batch number field 13b. In this manner, the corrupted binary image code may be provided to the user only with the first encrypted secure environment, and after it is loaded into the modified programmer it may be repeatedly used by modifying the batch number and the counter values stored in the secure data block in the secure memory of the modified programmer by means of such new encrypted secure environment packets.

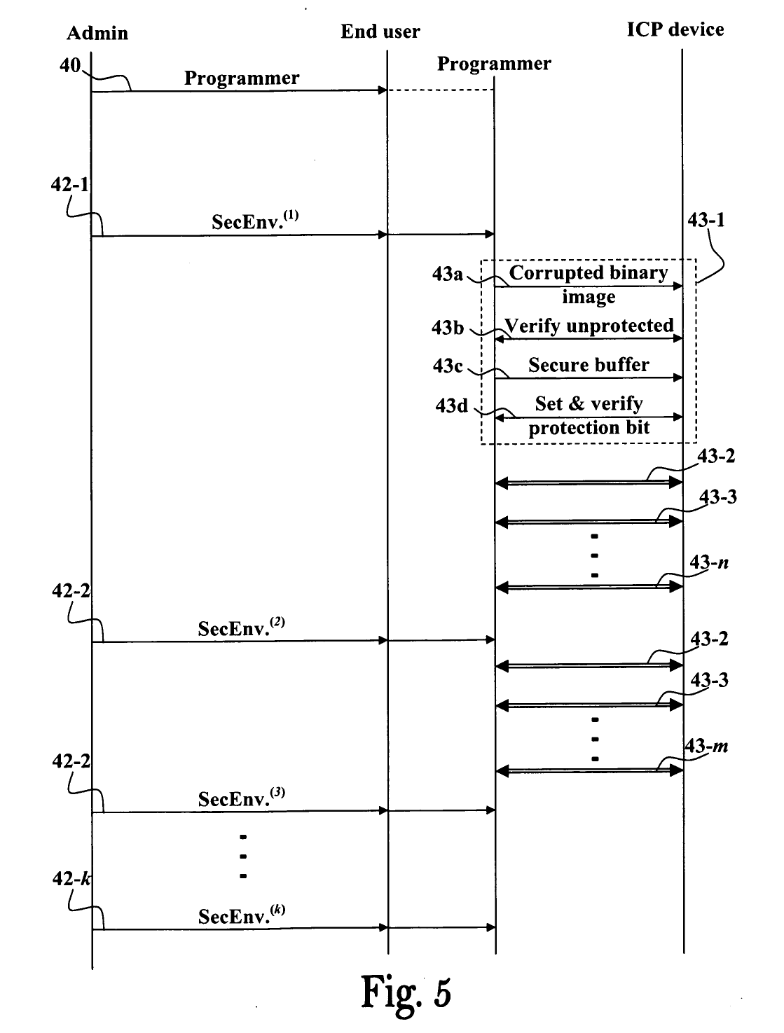

FIG. 5 schematically illustrates steps in the secure ICP programming process according to a preferred embodiment of the invention. This process starts in steps 40, and 42-1, in which the components of the secure ICP system 19 of the invention are received and installed at the end user.

Typically, the programmer of the invention (i.e., modified programmer 12 comprising the secure data block 13) received in step 40 is connected to a computer machine (10) in which a suitable loader is installed. Thereafter, in step 42-1, upon receipt of the encrypted secure environment packet (11—SecEnv.) comprising the corrupted binary image code (11f) and the secure environment definitions (11v), the end user loads the encrypted secure environment packet by means of the loader into the modified programmer 12.

The modified programmer 12 decrypts the encrypted packet (11) extracts from the secure environment definitions (11v) the data values needed for the secure data block and stores the same in the secure memory 15m. In a preferred embodiment of the invention the security parameters included in the secure environment comprise a security ID identifier, a new batch number value and a new counter value. When modified programmer receives a new encrypted secure environment packet (11) in step 42-1 it decrypts the packet using the password or encryption key (13k) and then compares the security ID identifier comprised in the secure environment to the security ID identifier stored in the security ID identifier field 13i in the secure memory. If these security ID identifiers are not identical the packet is denied and no further actions are performed. Next, if the security ID identifiers are identical, the modified programmer compares the new batch number value comprised in the secure environment to the old batch number value stored in the batch number field 13b in the secure memory. If the new batch number value is not greater than the old batch number value the packet is denied and no further actions are performed. If however the new batch number is greater than the old value then the new batch number value and the new counter value comprised in the secure environment are stored in their respective fields 13b and 13n in the secure data block 13 in the secure memory 15m. This mechanism advantageously prevents repeated use of the same secure environment by the user i.e. an attempt to re-load the same environment will be prevented.

In step 43-1 the modified programmer 12 performs a sequence of data transfers of binary image code sections and verifications to an ICP device (14). In a preferred embodiment of the invention initially in step 43a the corrupted binary image code is transferred and written in the nonvolatile memory of the ICP device (14). This step is typically completed within few seconds.

Next, in step 43b the programmer verifies that the data was written properly, which is typically also completed within few seconds. In step 43c the programmer performs the operations needed for restoring the corrupted code section (11e), as defined in the secure buffer (13e).

If for example, the corrupted code section was produced by applying a reversible manipulation (e.g., scrambling, bit shifting, modular arithmetic operators) to the op-code stored therein, then in step 43c the programmer restores the corrupted section code (11e) into its original executable form by applying the inverse operators to the data stored in the corrupted code section in the microcontroller memory.

In a preferred embodiment of the invention the original executable code (11e) is simply removed from the binary image file and stored in the secure buffer (13e) in modified programmer 12, and the locations of the removed data are filled with random dummy values, as described hereinabove with reference to FIG. 4. In this preferred embodiment step 43a may comprise transferring only sections (11s) of the corrupted binary image which were not corrupted. Furthermore, in this preferred embodiment step 43c is preferably carried out by simply writing the copied code section stored in the secure buffer (13e) into the predefined memory address locations in the ICP device in which the corrupted code is stored, as required for restoring the binary image into its original executable state. This step is typically carried out within few milliseconds (<100 ms). Finally, is step 43d the programmer sets the protection bit, which is also carried out within few milliseconds (<100 ms), thereby preventing any further access to the ICP device memory.

The binary image transfer procedure defined in steps 43a to 43d thus establishes a secure binary image transfer which is proof against code copying attacks. Since the last two steps 43c and 43d are carried out within few milliseconds an opponent attempting to disconnect the ICP device before the protect bit is set in order to access the ICP device memory and copy the program code written therein, will most probably obtain a copy of the corrupted or incomplete binary image. As explained hereinabove, this corrupted binary image is useless, and most probably not executable.

Accordingly, programmer 12 of the invention is preferably configured to carry out firmware programming comprised of the following programming steps: i) writing the corrupted binary image data into to the memory of the ICP device; ii) writing the code section removed from the binary image into the range of addresses in the ICP device corresponding the range of addresses from which it was removed, as defined in the secure buffer; and iii) setting the protection bit(s) to prevent copy of the restored binary image. Step i) may include writing only code sections of the corrupted binary image code which were not corrupted (11s). This mode of operation is particularly needed in certain types of microcontrollers which do not have rewritable memories (e.g., EPROM).

After transferring the binary image data to the first ICP device a sequence of further n-1 (where n is an integer) binary image data transfers may be followed in steps 43-2 to 43-n until the value stored in the counter field (13n) in the secure data block in programmer 12 is zeroed. As exemplified in steps 42-2 to 42-k, programmer 12 may be used to program additional ICP devices, however each new batch of binary image transfers requires receipt of a new encrypted packet (SecEnv.⁽²⁾ . . . SecEnv.^{(k)} for setting new value in the counter field (13n) and a new value in the batch number field (13b).

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A secure programming system for securely transferring binary image code to the memory of a microcontroller, the system comprising a modified programmer device and a computer machine capable of loading said modified programmer device with data, wherein said modified programmer device comprises processing means and a secure memory accessible by said processing means, and wherein said modified programmer device is adapted to receive from said computer machine data comprising a corrupted binary image code, transfer said corrupted binary image code into said memory of said microcontroller, restore sections of the code written in said memory of said microcontroller in order to restore said binary image code into its original executable state, and lock the microcontroller memory.

2. A system according to claim 1 wherein the modified programmer device is adapted to transfer the binary image code to the memory of the microcontroller in a sequence of data transfers and verifications comprising: i) transfer of the corrupted binary image code; ii) verification of the transferred data; iii) restoration of the at least one corrupted code section written in said memory of said microcontroller; and iv) lock of said memory of said microcontroller.

3. A system according to claim 1, wherein the corrupted binary image code comprises at least one code section which was corrupted by means of reversible data manipulation operators, and wherein the modified programmer is adapted to apply corresponding inverse operators to said at least one code section stored in the memory of the microcontroller.

4. A system according to claim 1, wherein at least one code section of the binary image code is stored in the secure memory of the modified programmer device, and wherein the locations of said at least one code section in said corrupted binary image code comprise random values, and wherein the modified programmer is adapted to replace said random values comprised in said at least one code section in the memory of the microcontroller with said at least one code section stored in said secure memory.

5. A system according to claim 4, wherein the code sections removed from the binary image code are of crucial importance for proper operation of the binary image code.

6. A system according to claim 1 wherein the secure memory of the modified programmer further comprises a password and/or cryptographic key(s) stored therein and wherein the modified programmer is further adapted to carry out cryptographic tasks.

7. A system according to claim 1, further comprising a counter field in the secure memory of the modified programmer device, said counter field comprising a counter value, wherein said modified programmer device is further adapted to decrement the counter value stored in said counter field whenever a binary image data transfer operation is performed, and to permit transfer of the binary image code only if the value stored in said counter field is greater than zero.

8. A system according to claim 6, wherein the data transferred to the modified programmer comprises encrypted secure environment data comprising the corrupted binary image code and security parameters comprising a new counter value, and wherein said modified programmer is adapted to decrypt said encrypted secure environment data by means of the password and/or cryptographic key(s).

9. A system according to claim 1, further comprising a batch number field in the secure memory of the modified programmer device.

10. A system according to claim 8 wherein the security parameters comprised in the encrypted secure environment further comprise a new batch number value, and wherein the modified programmer is further adapted to replace the values stored in the batch number field and in the counter field with said new batch number value and the new counter value, respectively, as comprised in the encrypted secure environment whenever said new batch number value is greater than the value stored in the said batch number field.

11. A programmer device for secure firmware programming comprising processing and memory means integrated in a single integrated circuit chip, said memory means is accessible by said processing means only, interfacing means capable of communicating said programmer device with a computer machine and interfacing means capable of communicating said programmer device with a programmable microcontroller device, wherein said memory means comprises information useful for restoring corrupted code sections of a corrupted binary image file to be transferred to said programmable microcontroller device, and wherein said programmer device is adapted to transfer code sections of said corrupted binary image file to said programmable microcontroller, restore said corrupted sections and transfer them to said programmable microcontroller and lock said memory means immediately thereafter.

12. A device according to claim 11 wherein the programmer device is adapted to transfer the corrupted binary image file to the memory of the programmable microcontroller, restore the corrupted sections stored in said memory of said programmable microcontroller, and lock said memory immediately thereafter.

13. A method for securely programming a microcontroller with a binary image code comprising:
Providing a corrupted version of said binary image code in which at least one section of code was corrupted by means of reversible data manipulation operators;
Providing a modified programmer device capable of restoring said at least one corrupted section of code by applying inverse data manipulations operators;
Loading said corrupted version of said binary image code into said modified programmer; and
Operating said modified programmer to transfer sections of said corrupted version of said binary image code to a memory of said microcontroller, restore said at least one corrupted section of code and transfer it into said memory of said microcontroller, and lock said memory thereafter.

14. A method according to claim 13, wherein the corrupted version of the binary image code is provided by removing at least one section of code of the binary image code and storing it in a secure memory of the modified programmer, and by replacing the locations of at least one section of code with random data, and wherein the modified programmer device is adapted to restore said at least one corrupted section by writing said at least one section of code stored in its secure memory into the respective locations in the memory of the microcontroller.

15. A method according to claim 13, wherein data transfer operations carried out by the modified programmer comprise transferring the corrupted version of the binary image code to a memory of the microcontroller, verification of the transferred data, restoration of the at least one corrupted code section written in said memory of said microcontroller, and lock of said memory of said microcontroller.

16. A method according to claim 13 further comprising decrementing a counter value stored in a counter field in a secure memory of the modified programmer, and transferring data to microcontroller devices only if the value stored in said counter field is greater than zero.

17. A method according to claim 16 wherein the corrupted binary image file is provided as part of an encrypted secure environment data further comprising security parameters comprising a new counter value to be stored in the counter field, and wherein the method further comprises decrypting said encrypted secure environment data by means of a password or cryptographic key(s) stored in secure memory of the modified programmer.

18. A method according to claim 17 further comprising a batch number field in the secure memory of the modified programmer, wherein the method further comprises storing a new batch number value comprised in the secure environment in said batch number field and the new counter value in the counter field if said new batch number value is greater than the value stored in said batch number field.

19. A secure programming system for securely transferring binary image code to the memory of a microcontroller, the system comprising a modified programmer device and a computer machine capable of loading said modified programmer device with data, wherein said modified programmer device comprises processing means and a secure memory accessible by said processing means, and wherein said modified programmer device is adapted to receive from said computer machine data comprising a corrupted binary image code comprising one or more corrupted code sections, transfer sections of said corrupted binary image code into said memory of said microcontroller, restore said one or more code sections of the corrupted binary image code and transfer them into said memory of said microcontroller in order to restore said binary image code into its original executable state, and lock the microcontroller memory.

20. A system according to claim 19 wherein the modified programmer device is adapted to transfer the binary image code to the memory of the microcontroller in a sequence of data transfers and verifications comprising: i) transfer the sections of the corrupted binary image code; ii) verification of the transferred data; iii) restoration of the at least one corrupted code section of said corrupted binary image code and transfer them to said microcontroller; and iv) lock of said memory of said microcontroller.

21. A system according to claim 19, wherein the corrupted binary image code comprises at least one code section which was corrupted by means of reversible data manipulation operators, and wherein the modified programmer is adapted to apply corresponding inverse operators to said at least one code section and store the same in the memory of the microcontroller.

22. A system according to claim 19, wherein at least one code section of the binary image code is stored in the secure memory of the modified programmer device, and wherein the locations of said at least one code section in said corrupted binary image code comprise random values, and wherein the modified programmer is adapted to transfer said at least one code section of the binary image code stored in the secure memory to respective locations in the memory of the microcontroller.

23. A system according to claim 19 wherein the secure memory of the modified programmer further comprises a password and/or cryptographic key(s) stored therein and wherein the modified programmer is further adapted to carry out cryptographic tasks.

24. A system according to claim 19, further comprising a counter field in the secure memory of the modified programmer device, said counter field comprising a counter value, wherein said modified programmer device is further adapted to decrement the counter value stored in said counter field whenever a binary image data transfer operation is performed, and to permit transfer of the binary image code only if the value stored in said counter field is greater than zero.

25. A system according to claim 23, wherein the data transferred to the modified programmer comprises encrypted secure environment data comprising the corrupted binary image code and security parameters comprising a new counter value, and wherein said modified programmer is adapted to decrypt said encrypted secure environment data by means of the password and/or cryptographic key(s).

26. A system according to claim 19, further comprising a batch number field in the secure memory of the modified programmer device.

27. A system according to claim 25 wherein the security parameters comprised in the encrypted secure environment further comprise a new batch number value, and wherein the modified programmer is further adapted to replace the values stored in the batch number field and in the counter field with said new batch number value and the new counter value, respectively, as comprised in the encrypted secure environment whenever said new batch number value is greater than the value stored in the said batch number field.
